(19) United States
(12) Patent Application Publication
(10) Pub. No.: US 2007/0095473 A1
(43) Pub. Date: May 3, 2007

(54) Process for adhering a liner to the surface of a pipe by induction heating

(76) Inventors: Kimberly Dawn Farnsworth, Walker, WV (US); Laurence Waino McKeen, Sewell, NJ (US); William Isaac Hoffman, Hendersonville, NC (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/586,287

(22) Filed: Oct. 25, 2006

Related U.S. Application Data
(60) Provisional application No. 60/730,263, filed on Oct. 26, 2005.

(51) Int. Cl. B32B 37/00

(52) U.S. Cl. 156/294

(57) ABSTRACT

The present invention relates to a process for adhering a preformed polymer liner to the surface of a pipe by induction heating the pipe. The liner may comprise a fluoropolymer. The liner may be applied either to the interior surface or the exterior surface of the pipe. The invention is particularly useful for adhering a liner to the interior surface of an oil well pipe. Thus with the induction heating process of present invention, it is possible to adhere a preformed liner to the interior surface of an oil well pipe which is capable of reducing-to-eliminating the deposition (buildup) of one or more of the asphaltenes, paraffin wax, and inorganic scale on the interior surface of the oil pipe. Preferably, this reduction is at least 40%, preferably at least 50% or more, for at least one of these materials as compared to the unlined oil pipe, and more preferably at least 40% for all of them. In one preferred embodiment of the process, the peel strength of the preformed liner adhered to the surface of the pipe is at least ten pounds force per inch (10 lbf/in). In other preferred embodiments of the process, either a primer or an adhesive aid is used in adhering the preformed liner to the surface of the pipe.

### FIELD OF THE INVENTION

This invention relates to a process for adhering a liner to the surface of a pipe, and in particular, an oil well pipe, by induction heating the pipe. The induction heating conducts heat to the liner, thereby adhering the liner to the surface of the pipe. The liner may comprise a fluoropolymer.

### BACKGROUND OF THE INVENTION

Pipes used in the production and transportation of chemicals are subject to corrosion and plugging. An example of such a pipe is oil pipe which is generally large and for reasons of economy is manufactured from carbon steel rather than more expensive corrosion resistant alloys. Corrosion is induced by the hot underground environment in which down-hole pipes convey oil from deeply buried deposits to the earth's surface. Materials such as water, sulfur, sulfur dioxide, carbon dioxide, present in the oil typically make it acidic causing corrosion of the interior surface of the pipe. Even at cooler temperatures, transportation pipelines that extend for long distances close to the earth's surface experience the effects of corrosion because of the long contact times involved. Corroded pipes are difficult and expensive to replace.

Methods of lining tubular members such as pipes are known; see for example, U.S. Pat. No. 2,833,686 to Sandt and Research Disclosure No. 263060, which both describe liners made of polytetrafluoroethylene, which is a non-melt processible fluoropolymer. Both of these references use a fluorinated ethylene propylene bonding agent, which does not provide particularly good adherence because of the non-stick properties of fluoropolymers generally.

A fluoropolymer preformed liner for a pipe is disclosed in U.S. Pat. No. 3,462,825 to Pope. However, pressure and temperature cycling that may occur in the use of such lined pipes may cause the lining to buckle, pulling away from the interior surface allowing accumulation of gases and liquids between the liner and the wall surface. This accumulation results in blistering at the metal interface and eventual buckling of the liner to constrict and possibly block the interior of the pipe.

WO 2005/100843 discloses the use of a preformed liner of fluoropolymer adhered to a pipe's surface with the aid of a primer layer containing a fluoropolymer and a heat resistant polymer binder.

EP 0278 685 employs photocurable epoxy adhesives for bonding fluoropolymers to metal substrates.

What would be desirable is a pipe with an interior surface which resists the deposit of insoluble organic materials and inorganic materials and has resistance to the corrosive effects of acids. Further there is a desire that the interior surface be durable and adhere well to the pipe, and not likely to buckle, when subjected to such corrosive conditions for many years in harsh environments.

### BRIEF SUMMARY OF THE INVENTION

With the present invention, induction heating is applied to the lined pipe. The heat is transferred from the pipe to the outside of the liner enabling the outside of the liner to reach a higher temperature than the inside of the liner, so that it sticks to the pipe while the inside of the liner remains cooler during heating. This allows the liner to maintain its shape, thereby limiting collapse as well as shrinkage.

Moreover, the liner has a greater shrinkage during cooling than the pipe, which would tend to pull the liner away from the interior surface of the pipe. The use of induction heating helps to mitigate this effect.

By preventing the liner from buckling or pulling away from the interior surface of the pipe, the use of induction heating, according to the present invention, causes adherence of the liner to the interior surface of the pipe, thereby preventing the accumulation of gases and liquids between the liner and the wall surface and consequent narrowing of the path of oil flow.

Therefore, with the induction heating process of the present invention, it is possible to adhere a preformed liner to the interior surface of an oil well pipe which is capable of reducing-to-eliminating the deposition (buildup) of one or more of the asphaltenes, paraffin wax, and inorganic scale on the interior surface of the oil pipe. Preferably, this reduction is at least 40%, preferably at least 50% or more, for at least one of these materials as compared to the unlined oil pipe, and more preferably at least 40% for all of them. These percent reductions can be determined by periodic measurements of the amount of build-up within the pipe or simply by observing the increase to more than double the production time before the oil well must be shut down for cleaning. These deposition reductions are accompanied by the added benefit of corrosion protection as compared to unlined oil pipes. The reduced deposition performance of the lined pipes of the present invention is in contrast to the result obtained for epoxy resin-lined oil pipes having an epoxy resin interior lining which is in contact with the oil.

Therefore, in accordance with the present invention, there is provided a process for adhering a preformed liner comprising a polymer to the interior surface of a pipe, comprising induction heating the pipe to conduct heat to the liner, thereby adhering the liner to the surface of the pipe.

The induction heating process of the present invention is especially useful in adhering a preformed liner which is made of fluoropolymer to the interior and/or exterior surface of a pipe. Therefore, further in accordance with the present invention, there is provided a process for adhering a preformed liner to the surface of a pipe, wherein the liner comprises in one embodiment a melt-processible fluoropolymer and in another embodiment a non-melt-processible fluoropolymer, comprising induction heating the pipe to conduct heat to the liner, thereby adhering the liner to the surface of the pipe. Further, the induction heating process of the present invention provides a pipe wherein the preformed liner adhered to the surface of the pipe has a peel strength of at least ten pounds force per inch (10 lbf/in), preferably at least fifteen pounds force per inch (15 lbf/in) and more preferably at least twenty pounds force per inch (20 lbf/in).

The induction heating process of the present invention is also particularly useful in adhering a preformed liner comprising a polymer to the interior surface of an oil well pipe. Therefore, in accordance with the present invention, there is provided a process for adhering a preformed liner to the interior surface of an oil well pipe, comprising induction heating the pipe to conduct heat to the liner, thereby adhering the liner to the surface of the pipe.

### DETAILED DESCRIPTION OF THE INVENTION

The present invention is directed to a process for adhering a preformed liner comprising a polymer to the interior surface of a pipe by induction heating. According to the present invention, the preformed liner is adhered to the interior surface of the pipe, or in certain embodiments may be adhered to the interior and/or exterior surface of the pipe. While the discussion herein focuses on preformed liners inserted inside the pipe, it will also occur to those skilled in the art that at least in the melt-processible embodiment, as discussed below, the preformed liner can be inserted: 1) on the interior surface of the pipe, 2) as a sleeve on the outside of the pipe, or 3) both. The preformed liner would be useful in reducing the corrosive effects of the environment, even though the environments encountered inside and outside the pipe are different. A change in the location of the preformed liner from the inside to the outside of the pipe, or adding an additional preformed layer outside the pipe would simply be an additional embodiment of this disclosure and would not be a departure from the spirit of this invention.

In particular, the pipe may be an oil conveying pipe, or oil pipe. The oil pipe of the present invention may be used as a succession of such pipes in an oil transportation pipeline or a down-hole oil well pipeline, it being understood, however, that the pipe of the present invention is not so limited. Oil pipes are generally large, having an inner diameter of at least 2 in (5 cm) and sometimes as large as 6 in (15.24 cm) and length of at least 10 ft (3 m), more often at least 20 ft (6.1 m) and often a length of at least 30 ft (9.1 m).

The pipes are typically made from rigid metal, although they could be made of flexible metal tubing. For reasons of economy they are usually made of carbon steel and as such are prone to corrosive attack from acidic entities in the oil, unless protected by a corrosion resistant coating. In this invention, a preformed liner which is both corrosion resistant and which possesses good release characteristics is applied to the interior surface of the pipe. Beneficial effects are also seen for pipes that are made from other substrates such as aluminum, stainless steel and other corrosion resistant alloys.

While the relative dimensions of the oil pipe made in accordance with the present invention are large, the thickness of the liner, and the primer layer or adhesive, if used, is quite small. In a preferred embodiment, the preformed liner typically has a thickness from about 20 mils to about 250 mils (500-6250 micrometers), more preferably about 30 mils to about 200 mils (750-5100 micrometers), even more preferably from about 20 mils to about 100 mils (500-2500 micrometers), and most preferably 30 to 100 mils (750 to 2500 micrometers). The adhesive or the primer layer, if used, need only be thick enough to adhere the preformed liner to the interior surface of the oil pipe. For instance, when a primer layer is used, the primer layer has a thickness in the range of 5-100 micrometers, and preferably 10-30 micrometers, sufficient to adhere the preformed liner to the interior surface of the pipe.

The vastness of the interior surface of this pipe over which the liner is unsupported except by adhesion to the interior surface of the pipe requires high integrity for the adhesion. Otherwise the varying conditions of temperature, pressure and even mechanical contacts can cause the liner to separate from the interior surface, leading to loss in corrosion protection and possibly even non-stick protection if the liner ruptures. Furthermore, separation of the liner may result in collapse of the liner, causing reduced flow or even plugging.

Therefore, according to the present invention, either an adhesive or a primer layer may be used to provide the adhesion of the preformed liner to the interior surface of the pipe, although under certain conditions the liner may be adhered without either an adhesive or a primer layer. The term adhesion or adhered means that the liner passes the 90° Peel Test, as will be described below in the Examples. The peel strength which can be achieved by the present invention is at least ten pounds force per inch (10 f/in), preferably at least fifteen pounds force per inch (15 lbf/in) and more preferably at least twenty pounds force per inch (20 lbf/in). If an adhesive is used, the adhesive may be selected from a variety of materials which can be cured at elevated temperatures. In one preferred embodiment, the adhesive is a thermoset adhesive. The adhesive may be an epoxy. Epoxies which contain no volatile solvents are particularly well-suited for use with the present invention, because no volatiles will be released/trapped between the pipe wall and the liner. The thermoset adhesive, used in this invention is cured at a temperature which is at least 50° C. less than the melting point of the polymer in the preformed liner, preferably at least 75° C., and more preferably at least 100° C. The thermoset adhesive is preferably epoxy.

Additionally, epoxies which are thermosets that cure at relatively low temperatures are desirable to use. Epoxy cure temperatures are generally less than 500° F. (260° C.) and may be much lower. Thus, in general, epoxies are processed at a lower temperature than fluoropolymer primers so that the maximum temperatures needed with the adhesive embodiment are lower than those needed with the primer layer embodiment. This translates to reduced shrinkage forces upon cool down.

An example of a commercially available epoxy which may be used with the present invention is ECCOBOND® A 359. This epoxy is a one part thermoset epoxy marketed by Bondmaster. Cure cycle ranges from 90 min at 100° C. to 40 seconds at 200° C. This epoxy is filled with aluminum and has a consistency of a thick paste. Service temperature range is −40 to 356° F. (−40 to +180° C.).

Other adhesives suitable for use with the present invention include, but are not limited to, silicones, polyamides, polyurethanes, and acrylic based systems. In addition, a primer layer, in particular comprising a fluoropolymer, may be desirable to use instead of the adhesive to effect adherence of the liner in the present invention.

In certain embodiments of the present invention, including the oil well pipe embodiment, the preformed liner may comprise a fluoropolymer. The fluoropolymer is selected from the group of polymers and copolymers of trifluoroethylene, hexafluoropropylene, monochlorotrifluoroethylene, dichlorodifluoroethylene, tetrafluoroethylene, perfluorobutyl ethylene, perfluoro(alkyl vinyl ether), vinylidene fluoride, and vinyl fluoride and blends thereof and blends of the polymers with a nonfluoropolymer.

In one embodiment, the fluoropolymers used in this invention are melt-processible. By melt-processible it is meant that the polymer can be processed in the molten state (i.e., fabricated from the melt into shaped articles such as films, fibers, and tubes etc. that exhibit sufficient strength and toughness to be useful their intended purpose). Examples of such melt-processible fluoropolymers include copolymers of tetrafluoroethylene (TFE) and at least one fluorinated copolymerizable monomer (comonomer) present in the polymer in sufficient amount to reduce the melting point of the copolymer substantially below that of TFE homopolymer, polytetrafluoroethylene (PTFE), e.g., to a melting temperature no greater than 315° C. Such fluoropolymers include polychlorotrifluoroethylene, copolymers of tetrafluoroethylene (TFE) or copolymers of chlorotrifluoroethylene (CTFE). Preferred comonomers of TFE are perfluoroolefin having 3 to 8 carbon atoms, such as hexafluoropropylene (HFP), and/or perfluoro(alkyl vinyl ether) (PAVE) in which the linear or branched alkyl group contains 1 to 5 carbon atoms. Preferred PAVE monomers are those in which the alkyl group contains 1, 2, 3 or 4 carbon atoms, and the copolymer can be made using several PAVE monomers. Preferred TFE copolymers include FEP (TFE/HFP copolymer), PFA (TFE/PAVE copolymer), TFE/HFP/PAVE wherein PAVE is PEVE and/or PPVE and MFA (TFE/PMVE/PAVE wherein the alkyl group of PAVE has at least two carbon atoms).

The melt-processible copolymer is made by incorporating an amount of comonomer into the copolymer in order to provide a copolymer which typically has a melt flow rate of about 1-100 g/10 min as measured according to ASTM D-1238 at the temperature which is standard for the specific copolymer. Typically, the melt viscosity will range from 10² Pa·s to about 10⁶ Pa·s, preferably 10³ to about 10⁵ Pa·s measured at 372° C. by the method of ASTM D-1238 modified as described in U.S. Pat. No. 4,380,618. Additional melt-processible fluoropolymers are the copolymers of ethylene or propylene with TFE or CTFE, notably ETFE, ECTFE, PCTFE, TFE/ETFE/HFP (also known as THV) and TFE/E/HFP (also known as EFEP). Further useful polymers are film forming polymers of polyvinylidene fluoride (PVDF) and copolymers of vinylidene fluoride as well as polyvinyl fluoride (PVF) and copolymers of vinyl fluoride.

In another embodiment, polytetrafluoroethylene (PTFE) including modified PTFE which is not melt-processible may be used together with melt-processible fluoropolymer or in place of such fluoropolymer. By modified PTFE is meant PTFE containing a small amount of comonomer modifier which improves film forming capability during baking (fusing), such as perfluoroolefin, notably hexafluoropropylene (HFP) or perfluoro(alkyl vinyl)ether (PAVE), where the alkyl group contains 1 to 5 carbon atoms, with perfluoro(ethyl vinyl) ether(PEVE) and perfluoro(propyl vinyl)ether (PPVE) being preferred. The amount of such modifier will be insufficient to confer melt fabricability to the PTFE, generally no more than 0.5 mole %. The PTFE, also for simplicity, can have a single melt viscosity, usually at least 1×10⁹ Pa·s, but a mixture of PTFE's having different melt viscosities can be used to form the fluoropolymer component. Such high melt viscosity indicates that the PTFE does not flow in the molten state and therefore is not melt-processible. It should be noted that when PTFE is used as the preformed liner, either an adhesive or a primer layer should preferably be used.

In one embodiment of the present invention, a primer layer is used instead of an adhesive to adhere the preformed liner to the pipe. The primer layer may comprise a fluoropolymer. The fluoropolymer can be the same as described above with respect to the fluoropolymer used for the preformed liner.

A preferred ingredient in the primer is a heat resistant polymer binder, the presence of which enables the primer layer to adhere to the interior surface of the pipe. The binder component is composed of polymer which is film-forming upon heating to fusion and is also thermally stable. This component is well known in primer applications for nonstick finishes, for adhering the fluoropolymer-containing primer layer to substrates and for film-forming within and as part of a primer layer. The fluoropolymer by itself has little to no adhesion to the interior surface of the metal pipe. The binder is generally non-fluorine containing and yet adheres to the fluoropolymer.

Examples of the non-fluorinated thermally stable polymer binders include polyamideimide (PAI), polyimide (PI), polyphenylene sulfide (PPS), polyether sulfone (PES), polyarylene-etherketone, polyetherimide, and poly(1,4(2,6-dimethylephenyl)oxide) commonly known as polyphenylene oxide (PPO). These polymers are also fluorine-free and are thermoplastic. All of these resins are thermally stable at a temperature of at least 140° C. Polyethersulfone is an amorphous polymer having a sustained use temperature (thermal stability) of up to 190° C. and glass transition temperature of 220° C. Polyamideimide is thermally stable at temperatures of at least 250° C. and melts at temperatures of at least 290° C. Polyphenylene sulfide melts at 285° C. Polyaryleneether-ketones are thermally stable at least 250° C. and melt at temperatures of at least 300° C. When the primer composition is applied as a liquid medium, the adhesion properties described above will manifest themselves upon drying and baking of the primer layer together with baking of the next applied layer of fluoropolymer to form the nonstick coating of the substrate.

The polymer binder can be applied as an undercoat to the pipe interior surface after treatment to remove contaminants and a solvent solution thereof, prior to application of the primer. The resultant dried thin film of polymer binder can further enhance the adhesion of the primer layer to the pipe interior surface.

For simplicity, only one binder resin may be used to form the binder component of the primer composition of the present invention. However, multiple binder resins are also contemplated for use in this invention, especially when certain end-use properties are desired, such as flexibility, hardness, or corrosion protection. Common combinations include PAI/PES, PAI/PPS and PES/PPS.

Other ingredients can be present in the primer, such as pigments, fillers, high boiling liquids, dispersing aids, and surface tension modifiers.

The primer layer is preferably liquid-based. The liquid basis of the primer coating is preferably an organic solvent. Although water-based primers may be used in some applications, the use of solvent deters the creation of rust on the interior surface of the pipe which may interfere with adhesion of the primer layer to the surface of the pipe.

The preferred liquid which enables the primer to be a liquid composition is one or more organic solvents, within which the fluoropolymer, present as particles, is dispersed and the polymer binder present either as dispersed particles or in solution in the solvent. The characteristics of the organic liquid will depend upon the identity of the polymer binder and whether a solution or dispersion thereof is desired. Examples of such liquids include N-methylpyrrolidone, butyrolactone, methyl isobutyl ketone, high boiling aromatic solvents, alcohols, mixtures thereof, among others. The amount of the organic liquid will depend on the flow characteristics desired for the particular coating operation.

The solvent should have a boiling point of 50 to 200° C., so as not to be too volatile at room temperature, but to be vaporized at reasonable elevated temperatures, less than the baking temperature of the fluoropolymer. The thickness of the primer layer coating is established by experience with the particular primer composition selected, including its fluoropolymer and polymer binder concentrations and the relative amount of solvent that is present. The primer layer of the oil pipe preferably has a thickness of in the range of 5-100 micrometers, preferably 10-30 micrometers. Preferably the primer contains 40 to 75 wt % solvent based on the combined weight of solvent, fluoropolymer and polymer binder. When the primer is applied as a liquid to the pipe surface, the solvent is removed upon drying prior to the insertion of the preformed liner.

Powder coatings may also be used for the primer layer. Examples of suitable powder coating compositions comprising perfluoropolymer and polymer binder, wherein these components are associated with one another in multi-component particles are disclosed in U.S. Pat. Nos. 6,232,372 and 6,518,349. When the primer is applied as a dry powder, the adhesion property becomes manifest when the primer layer is baked.

The preformed fluoropolymer film can be made from melt processible polymers by well-known melt extrusion processes forming, as examples, preferred films of ETFE, FEP and PFA. Further the fluoropolymer film can be formed from fluid compositions that are either solutions or dispersions of fluoropolymer by casting or by plasticized melt extrusion processes. Examples include blends of polyvinylidene fluoride, or copolymers and terpolymers thereof, and acrylic resin as the principal components. PVF is a semicrystalline polymer that can be formed into a film by plasticized melt extrusion. Despite the fact that there are no commercial solvents for PVF at temperatures below 100° C., latent solvents such as propylene carbonate, N-methylpyrrolidone, y-butyrolactone, sulfolane, and dimethyl acetamide are used to solvate the polymer at elevated temperatures causing the particles to coalesce and permit extrusion of a film containing latent solvent that can be removed by drying.

In an especially preferred embodiment, the interior surface of the oil pipe has a barrier layer that forms a mechanical barrier against the permeation of water, solvent and oxygen to the pipe. The barrier layer is positioned between the primer layer and the preformed liner. The barrier layer has a typical thickness of about 1 to about 10 mils (25-254 micrometers). Preferably the barrier layer comprises a fluoropolymer and platelet shaped filler particles that are relatively inert to chemical attack. The fluoropolymer of the barrier layer is the same as that described above with respect to the fluoropolymer used for the preformed liner. The particles are present in the amount of about 2 to about 10% by weight based on the total dry weight of the barrier layer. In spray application, the particles tend to align parallel to the interior surface of the pipe. Since oxygen, solvent and water cannot pass through the particles themselves, the presence of aligned particle particles further reduces the rate permeation through the polymer film which is formed. Examples of typical platelet shaped filler particles include mica, glass flake and stainless steel flake. It is also within the scope of this invention that the preformed liner may contain platelet shaped filler particles with or without the presence of an intermediate barrier layer. In this embodiment, the particles are present in the preformed liner in the amount of from 2 to about 10% by weight based on the weight of the preformed liner. Such particles tend to align in the manufacture of a preformed liner during conventional extrusion processes and contribute to the permeation resistance of the liner formed on the interior surface of a pipe.

The platelet shaped particles of filler component of the barrier layer are preferably mica particles, including mica particles coated with an oxide layer like iron or titanium oxide. These particles have an average particle size of about 10 to 200 microns, preferably 20-100 microns, with no more than 50% of the particles of flake having average particle size of more than about 300 microns. The mica particles which coated with oxide layer are those described in U.S. Pat. No. 3,087,827 (Klenke and Stratton); U.S. Pat. No. 3,087,828 (Linton); and U.S. Pat. No. 3,087,829 (Linton).

The micas described in these Patents are coated with oxides or hydrous oxides of titanium, zirconium, aluminum, zinc, antimony, tin, iron, copper, nickel, cobalt, chromium, or vanadium. Mixtures of coated micas can also be used.

In a preferred embodiment the fluoropolymer in the preformed film of this invention is preferably selected from polyvinyl fluoride (PVF), fluorinated ethylene/propylene copolymer, ethylene/tetrafluoroethylene copolymer, tetrafluoroethylene/perfluoro(alkyl vinyl ether) copolymer, polyvinylidene fluoride and a blend of polyvinylidene fluoride and an acrylic polymer, preferably nonfluoropolymer acrylic polymer. The fluoropolymer in the primer layer and barrier layer, if used in this invention is preferably independently selected from melt-processible fluorinated ethylene/propylene copolymer, ethylene/tetrafluoroethylene copolymer, and tetrafluoroethylene/perfluoro(alkyl vinyl ether) copolymer.

The melting temperature of the liner will vary according to its composition. By melting temperature is meant the peak absorbance obtained in DSC analysis of the liner. By way of example, tetrafluoroethylene/perfluoro(propyl vinyl ether) copolymer (TFE/PPVE copolymer) melts at 305° C., while tetrafluoroethylene/hexafluoropropylene melts at 260° C. (TFE/HFP copolymer). Tetrafluoroethylene/perfluoro-(methyl vinyl ether)/perfluoro(propyl vinyl ether) copolymer (TFE/PMVE/PPVE copolymer) has a melting temperature in between these melting temperatures.

The fluoropolymers in the primer layer, if used, preformed liner and barrier layer, if used, can be the same or different, provided that when the pipe is heated, as will be described below, they adhere to one another. When the fluoropolymer composition or melting points are similar, adequate interlayer adhesion is obtained. In an especially preferred embodiment, the preformed liner consists essentially of, i.e., is a pure perfluoropolymer. In this embodiment, the primer layer may also comprise a perfluoropolymer. The perfluoropolymers in the primer layer and the preformed liner are preferably independently selected from the group consisting of (i) copolymer of tetrafluoroethylene with perfluoroolefin copolymer, the perfluoroolefin containing at least 3 carbon atoms, and (ii) copolymer of tetrafluoroethylene with at least one perfluoro(alkyl vinyl ether), the alkyl containing from 1 to 8 carbon atoms. Additional comonomers can be present in the copolymers to modify properties. Adequate interlayer adhesion is also obtained when one of the perfluoropolymers is copolymer (i) and the other is copolymer (ii). When a melt-processible fluoropolymer is used for the preformed liner, the preformed liner can be made by well-known melt extrusion processes forming, as examples, preferred liners of ETFE, FEP and PFA. Further the preformed liner can be made from fluid compositions that are either solutions or dispersions of fluoropolymer by casting or by plasticized melt extrusion processes. Examples include blends of polyvinylidene fluoride, or copolymers and terpolymers thereof, and acrylic resin as the principal components. PVF is a semicrystalline polymer that can be formed into a preformed liner by plasticized melt extrusion. Despite the fact that there are no commercial solvents for PVF at temperatures below 100° C., latent solvents such as propylene carbonate, N-methylpyrrolidone, 7-butyrolactone, sulfolane, and dimethyl acetamide are used to solvate the polymer at elevated temperatures causing the particles to coalesce and permit extrusion of a film containing latent solvent that can be removed by drying.

When a non-melt processible fluoropolymer is used for the preformed liner, the liner can be made, for example, by methods including paste extrusion as described in U.S. Pat. No. 2,685,707. In paste extrusion, a paste extrusion composition is formed by mixing PTFE fine powder with an organic lubricant which has a viscosity of at least 0.45 centipoise at 25° C. and is liquid under the conditions of subsequent extrusion. The PTFE soaks up the lubricant, resulting in a dry, pressure coalescing paste extrusion composition that is also referred to as lubricated PTFE fine powder. During paste extrusion which is typically performed at a temperature of 20 to 60° C., the lubricated fine powder is forced through a die to form a lubricated green extrudate. The lubricated green extrudate is then heated, usually at a temperature of 100 to 250° C., to make volatile and drive off the lubricant from the extrudate. In most cases, the dried extrudate is heated to a temperature close to or above the melting point of the PTFE, typically between 327° C. and 500° C., to sinter the PTFE.

Alternatively, granular PTFE can be isostatically molded or ram extruded into a tubular liner and fitted into a pipe housing to form the preformed liner. In this embodiment, the liner is processed to a size somewhat larger than the inner diameter (I.D.) of the steel housing into which it is being installed. The thickness is typically 50-120 mils. The liner is preferably pulled through a reduction die into a pipe that has either an adhesive or a primer layer applied thereto. A programmed heating cycle relaxes the liner inside the steel housing, resulting in a snug liner fit.

A pipe is made according to the process of the present invention in the following manner. Typically the as-manufactured and supplied pipe, such as an oil pipe, will have a coating of preservative (rust inhibitor) on the interior, relatively smooth surface to provide resistance to rust. The pipe interior surface may be cleaned and then roughened, for instance by grit blasting, thereby ridding such surface of contaminants that could interfere with adhesion and providing a more adherent surface for the liner. Conventional soaps and cleansers can be used. The pipe can be first cleaned by baking at high temperatures in air, temperatures of 800° F. (427° C.) or greater. The cleaned interior surface is then preferably grit blasted, with abrasive particles, such as sand or aluminum oxide, or can be roughened, such as by chemical etching, to form a roughened surface to improve the adhesion of the liner. The grit blasting is sufficient to remove any rust that may be present, thereby supplementing the cleaning of the interior surface. The roughening that is desired for liner adhesion can be characterized as a roughness average of 1-75 micrometers.

In accordance with the present invention, if an adhesive is used, the adhesive may be applied to the outside of the preformed liner, and the liner is inserted into the pipe. Alternatively, the adhesive or primer layer may be applied to the interior surface of the pipe and the liner is inserted into the pipe. As a specific example, in this primer layer embodiment, the primer composition is applied to a cleaned, grit-blasted interior surface of the pipe by spraying a liquid-based composition from a nozzle at the end of a tube extending into the interior of the pipe and along its longitudinal axis. The primer composition is preferably applied to a heated pipe in order to prevent running, dripping and sagging. Typically the pipe is preheated to 110-125° F. (43-52° C.) but higher temperatures may be used providing that they are about 20° F. below the boiling point of the solvent of the composition. The spraying starts at the far end of the pipe and is moved backward along its longitudinal axis as the spray applies the liquid-based coating, until the entire interior surface is coated. The tube having the spray nozzle at its end is supported along its length and positioned axially within the pipe by sled elements positioned along the length of the tube. As the tube and its nozzle is retracted from the pipe, the sled elements slide along the interior surface of the pipe, leaving the underlying interior surface open to receive the sprayed coating.

The surface of the preformed liner may be treated before the adhesive is applied, or if the adhesive is applied to the interior surface of the pipe, before the liner is inserted into the pipe. This treatment may include etching, which encompasses chemical or mechanical etching. Chemical etching in particular strips some of the fluorines off the surface leaving a surface which can be wet by epoxy, other adhesives, etc. Etching may be accomplished using a sodium ammonia etch. Other surface treatments for improving the adhesion of the preformed liner include flame treatment, corona discharge treatment and plasma treatment, all of which are described in Schiers, “Modern Fluoropolymers”, Wiley Series in Polymer Science, 1997. It should be noted that there are also other commercial means to treat or etch fluoropolymers, and the present invention is not limited to those means discussed herein.

In a “slip fit” embodiment, the preformed liner is tubular, with the outer diameter of the tube being slightly smaller than the inner diameter of the pipe to be lined. This allows the liner to be freely slipped into the pipe. Upon heating, the liner will expand and adhere firmly to the inside of the pipe.

In certain other embodiments, the preformed liner is tubular, with the outer diameter of the tube being greater than the interior diameter of the pipe to be lined. In a preferred embodiment the initial outer diameter of the preformed liner is about 10 to 15% greater than the inner diameter of the pipe. In a more preferred embodiment, the preformed liner is applied to the interior surface of the pipe according to the teachings of U.S. Pat. No. 3,462,825 (Pope et al.) by gripping one end of the liner, pulling the liner into the oil pipe mechanically reducing the outer diameter, releasing the liner and allowing the liner to expand into tight engagement with the adhesive or the primer layer (or barrier layer, if present) of the interior surface of the pipe. A preferred method for reducing the outer diameter is to pull the liner into the oil pipe through a reduction die as taught in Pope et al. Alternative means of reducing the diameter of the tubular liner such that it could be pulled into the oil pipe of smaller inner diameter include 1) pulling the tubular liner under tension such that the length of the liner increases and the diameter of the liner decreases as described in U.S. Pat. No. 5,454,419 to Vloedman or 2) pulling the tubular liner through diameter reducing rollers similar to those described in Canadian Patent 1241262 (Whyman et al). In either case, once the tubular liner is inserted in the oil pipe, it is released allowing the liner to expand into tight engagement with the adhesive (or barrier layer, if present) of the interior surface of the pipe.

An alternate method of producing a lined pipe is called swaging. In this embodiment, the preformed film is preferably in the shape of a tubular liner with the outer diameter of the tube being less than the interior diameter of the pipe to be lined. In a preferred embodiment, the initial outer diameter of the tubular liner is about 10 to 15% less than the inner diameter of the pipe. Swaging involves mechanically reducing the diameter of a steel pipe around a liner by use of a swaging device such as an Abby Etna Rotary Swager which applies an abundant amount of force to the pipe through hammering, for example applying 2400 blows per minute to cause the pipe to fit around the liner. As in the previously described process, the pipe is primed prior to having the liner inserted in it. After the liner is inserted and the pipe is “swaged” down around the liner, the pipe is heated.

Depending upon the specifics of the liner (wall thickness, % reduction, and exact material composition) a heat cycle may be required to relax/re-expand the liner tightly against the pipe walls. For instance, PTFE may not re-expand as fully without addition of heat by induction heating.

After the lining is inserted in the pipe, the pipe is then heated to heat the adhesive or the primer layer, if used, or to heat the liner, in order to adhere the lining to the interior surface of the pipe. The pipe is heated by induction heating, which is applied to the pipe to heat the pipe. Induction heating of a metallic component (the workpiece) is achieved by passing high-frequency electric current through a coil surrounding a workpiece. This in turn induces a high-frequency electromagnetic field in the piece. This field induces currents in the workpiece and the electrical resistance of the piece to the flow of current causes the piece to heat up. (It should be understood that the invention is not limited to any particular shape or coil, or to any particular location of the coil relative to the workpiece, provided that the shape and location of the coil are such that current changes in the coil induce the required electromagnetic field within the workpiece.)

It will also occur to those skilled in the art that the heating mechanism of this invention is not limited to induction heating. For example, exposure to any heat source sufficient to heat or in certain cases melt only the liner's outer skin (contacting the pipe) without melting the remainder of the liner would be suitable. These could also include but are not limited to, for example, flame treating and high temperature electrical resistance furnaces. Still other heat sources which can be used include the heat from a gas fired indirect heater. A very short duration heat source would also accomplish the objective. Detailed examples of such intense heat sources would include but are not limited to oxyacetylene torches and heating elements of molybdenum disilicide (available as Kanthal Super 33 heating elements from Kanthal Corporation, Bethel, Conn.).

In such an arrangement, very accurate temperature control could be achieved. This is because modest changes to the oven temperature would result in small temperature differences at the liner surface. The required oven temperature would then be determined empirically by adjusting the speed with which the pipe moves through the heated zone and the temperature of the zone.

This technique has been successfully applied to production of monofilaments (see, e.g. U.S. Pat. No. 4,921,668, Anderson, et. al. to DuPont) and U.S. Pat. No. 5,082,610, Fish, et. al. to DuPont) but has not been applied to lining pipes until now. These and other such changes in heating mechanism may all be made without departing from the spirit of this invention.

The heat in the pipe is sufficient to cause the liner to expand against the interior surface of the pipe and adhere the liner to the surface of the pipe. Depending on what adhesive is used, the heating may be sufficient to cure the adhesive. For instance, epoxies cure as they are heated, but other adhesives may not cure. In this case, the liner may be heated sufficiently to adhere it to the interior surface of the pipe, but not melt it.

The maximum pipe temperature varies according to the particular adhesive or primer composition being used, and may go up to 700° F., with the lower end of this temperature range being 200° F. (93° C.). Adherence temperatures are dependent on the particular composition of the preformed liner. In the primer layer embodiment, for liners of PFA, FEP, or PTFE, the pipe is heated by induction heating to a temperature between 500 to 700° F. (260 to 371° C.). For ETFE, the pipe is heated to a temperature between 5000 to 630° F. (260 to 332° C.). Time for adherence will be dependent on the heating temperature used, but the time of exposure to the maximum temperature is typically in the range of seconds for induction heating.

When a primer layer is used, the primer layer is consolidated from the dried liquid state or powder state to a solid film prior to insertion of the liner and the preformed liner is adhered to the primer layer. This consolidation will generally involve heating of both the primer layer and the preformed liner, either sequentially of simultaneously. That is to say, that the primer layer/preformed liner interface, or the interfaces of the primer layer/barrier layer/preformed liner as the case may be, are melted together sufficiently to adhere the preformed liner firmly to the primer layer. Heating time and temperature must be sufficient to achieve a firm melt bond between the preformed liner and the primer layer or barrier layer. Typically, heating is carried out by simply heating the layer(s) sufficiently above the melting temperature of the primer layer to cause the primer layer to flow and fuse with the preformed liner. The primer layer may only need to be partly consolidated, such as by drying if applied as a liquid-based composition and possibly partially fused, with complete consolidation occurring upon fusion bonding with the preformed liner.

In either the primer layer or the adhesive embodiment of the induction heating process of the present invention, the pipe moves in proximity to the heating induction coil at a scanning rate of 1-30 inches per minute, preferably 10-20. Alternatively, the heating induction coil is moved in proximity to the pipe at this rate.

According to the process of the present invention, after the heating step, the pipe is then cooled. The cooling rate may be controlled in different ways. Options for cooling include 1) room temperature air cooling or 2) via cooling rings, water jets, etc.

With the heat induction process of the present invention, the pipes can be moved along the heating induction coil, or vice versa, so that one can process large pipes without the need for a bulky, standard convection oven, which requires a large capital investment. Moreover, the process of the present invention allows the liner to be adhered in the field, allowing for on-site construction or repair, which significantly increases the flexibility of applying the liner.

The expansion of the preformed liner during the heating step, while theoretically greater than the expansion of the pipe, is limited by the relaxation effect of the heating of the liner to the molten or near molten condition. As the pipe cools, there is a tendency for the preformed liner to shrink. The shrinkage of the liner during cooling starts from this relaxed condition and then outpaces the shrinkage of the pipe. Under this condition, it is surprising that the adherence of the liner retains its integrity during cooling. Unexpectedly, the interlayer adhesion between the adhesive or primer layer (and barrier layer, if present) and the preformed liner is sufficient to prevent the liner from pulling away from the adhesive or primer layer or barrier layer. In the present invention, the expansion fit of the prior art for liner a pipe is improved by an adhered liner that resists separation and buckling characteristic of unadhered liners.

In prior art systems where adherence of a liner is poor, gas is able to permeate through the liner to both corrode the pipe and to exert pressure on the liner from the metal interface side of the film. This results in blistering at the metal interface and eventual buckling of the liner to constrict and possibly block the interior of the pipe. Pipes of the present invention are able to deter the permeation of gases and vapors and resist the accumulation of chemicals at the interface of the pipe and primer layer/liner or adhesive/liner greatly retarding catastrophic failure. Moreover, the preformed liner of the pipes of the present invention is sufficiently thick and defect free so as to minimize the passage of corrosive material to the interior surface of the pipe.

Therefore, for all of the foregoing reasons, pipes of the present invention are able to withstand the harsh conditions of oil production. These pipes are able to withstand typical reservoir conditions that are at least about 250° F. (121° C.) and 7,500 psi (52 MPa), with 275° F. (135° C.) and 10,000 psi (69 MPa) being quite common. The pipes of the present invention are also able to withstand conditions as high as 350° F. (177° C.) and 20,000 psi (138 MPa) present in some high temperature/high pressure reserves. The invention is also applicable to pipe used in the Chemical Processing Industry (CPI), especially in those applications where temperatures such as those described above are encountered. In the CPI temperatures of at least about 350° F. (177° C.) and even as high as 400° F. (204° C.) are used. The pipes of the preferred embodiment of this invention show superior permeation resistance to corrosive chemicals due to both to their construction, i.e., primer layer and thick preformed layer with an optional intervening barrier layer, and their strong adherence to the interior surface of the pipe. The lined pipes of the present invention are able to withstand the above described conditions for continuous service, e.g., for at least 30 days, preferably at least 60 days, and more preferably at least 12 months.

The preformed liner is impermeable to the corrosive materials present in the oil and presents a nonstick surface to the oil, whereby the insoluble organic materials present in the oil do not stick to the liner and restriction of oil flow and plugging is avoided. Further the preformed liner of the present invention is able to provide insulation to the oil pipe to mitigate the change from hot underground conditions to cooler earth surface effects, thereby resisting the deposit of the insoluble organic and inorganic materials. In addition, the preformed liner of the present invention possesses increased abrasion resistance to sand and rock contained in the oil and to effects of tools scraping on the interior surface of pipe as these instruments are being lowered into the well for various measuring or servicing operations. The preformed liners of this invention resist both penetration and wear.

Because of all the above-noted advantages, the present invention is capable of reducing the deposition of at least one of asphaltenes, paraffin wax and inorganic scale by at least 40%, and preferably at least 50%, as compared to the interior surface of the oil pipe without the lining being present. These reductions are also made in comparison to a pipe lined with only an epoxy resin on the interior surface of the pipe.

In fact, reductions of at least 60%, 70%, 80% and even at least 90% have been realized. Preferably these reductions apply to at least two of the deposition materials, and more preferably, to all three of them. Thus, in accordance with the present invention, there is also provided a method for reducing the deposition in a rigid oil well pipe of at least one of asphaltenes, paraffin wax, and inorganic scale by at least 40% as compared to the interior surface of the oil pipe without the liner being present. In addition, the preformed liner provides corrosion protection to the interior surface of the pipe;

### EXAMPLES

### Sample Preparation and Test Method

Adhesion Testing

Adhesion testing is performed using a modified version of ASTM D 6862-04 “Standard Test Method for 90 Degree Peel Test of Adhesives”. The test apparatus is the same as described in the ASTM. This apparatus allows for a 90° angle to be maintained between the preformed liner and the substrate (the carbon steel pipe) during the entire test. The test specimens are ⅜″-½″ wide strips cut vertically from the sample pipes. The test specimens are each ˜12 in long. Peel strength (lbf/in) is measured over at least 3 inches, (disregarding at least the first 1 inch of the peel as suggested in ASTM D 6862-04) and is reported as an average value. The superior adhesion of the substrate pipes with nonstick liners in the Examples of this invention is evident when a comparison is made to substrate pipes prepared in the Comparative Examples that are not heated via induction heating. That comparison is summarized in Table 5. As noted above, the peel strength which can be achieved by the present invention is at least ten pounds-force per inch (10 lbf/in), preferably at least fifteen pounds-force per inch (15 lbf/in), and more preferably at least twenty pounds-force per inch (20 lbf/in).

The primer layers formed in the Examples have the following pre-bake composition:

TABLE 1
Primer Layer

| | Primer |
|---|---|
| Ingredient | wt % |
| Fluoropolymer | |
| FEP | 12.5 |
| Polymer binder | |
| Polyamideimide | 1.1 |
| Polyethersulfone | 7.6 |
| Polyphenylene Sulfide | |
| Solvents | |
| NMP* | 47.8 |
| Other Organics** | 20.1 |
| Water | |
| Pigments | 9.9 |
| Dispersing Agent | 1.0 |
| Total | 100 |

*NMP is N-methyl-2-pyrrolidone
**Other organics may include solvents such as MIBK (methyl isobutyl ketone), hydrocarbons such as heavy naphtha, xylene etc., furfuryl alcohol, triethanol amine or mixtures thereof.
FEP: TFE/HFP fluoropolymer containing 11.1-12.4 wt % HFP, an average particle size of 8 micrometers and a melt flow rate of 6.5-7.5 g/10 min measured at 372° C. by the method of ASTM D-1238.

The barrier layer formed in the Examples has the following pre-bake composition:

TABLE 2
Barrier Layer

| | Barrier Layer A |
|---|---|
| Ingredient | wt % |
| PFA | 41.2 |
| Acrylic Thickener | 1.1 |
| Solvents | |
| Water | 42.8 |
| Glycerin | 8.3 |
| Other Organics** | 1.1 |
| Pigments | |
| Mica*** | 3.9 |
| Tin Metal | 1.2 |
| Surfactants | 0.4 |
| Total | 100 |

***Mica is red colored
PFA: TFE/PPVE fluoropolymer resin containing 3.2-4.1 wt % PPVE having a melt flow rate of 1.7-2.1 g/10 min and an average particle size of 35 micrometers.

The adhesive layers formed in the following Examples are comprised of a commercially available epoxy known as ECCOBOND® A-359 and have the following composition:

TABLE 3
Adhesive Layer

| | Adhesive Layer |
|---|---|
| Ingredient | Wt % |
| DGEBA Epoxy Resin | 30-60 |
| Aluminum | 10-30 |
| Mineral Filler, Curing Agent, Modifier | 1-10 |

DGEBA: Diglycidyl ether of bisphenol A

The pre-formed polymer liners in the Examples have the following compositions:

TABLE 4
Preformed Liner Layer

Preformed Liner

| Composition | PFA | PTFE |
|---|---|---|
| Wt % TFE | 95.8 | 100 |
| Wt % PPVE | 4.2 | |

In the following Examples, the substrates for adhering a preformed liner are carbon steel pipes with a 3 inch inner diameter (ID). The inside of the pipes is grit blasted with 40 grit aluminum oxide to a roughness of approximately 70-125 microinches (1.8-3.2 micrometers) Ra. Liquid primer and barrier coats are applied by using a spray gun, Model Number MSA-510 available from DeVilbiss located in Glendale Heights, Ill. The preformed liners may be fabricated via melt extrusion, in the case of melt processable fluoropolymers, or in the case of non-melt processible fluoropolymers by other standard processing techniques including ram extrusion, paste extrusion, or isostatic molding. The particular technique used for fabricating the liner does not effect the adherence results.

The preformed liners are applied to the interior surface of the pipe via two different techniques for practical reasons. In the Examples involving either no adhesives or a primer and barrier layer, the liner is applied to the interior surface of the pipe according to the teachings of U.S. Pat. No. 3,462,825 (Pope et al.) In these cases, the preformed liner has an outer diameter (OD) slightly larger (˜5%) than the inner diameter (ID) of the pipe. The liner is gripped on one end and pulled into the pipe mechanically reducing the outer diameter. Once inside the pipe, the liner is released and allowed to expand into tight engagement with the pipe or primer and barrier layer if present. In the following Examples, this technique will be referred to as “interference lining”.

In the Examples involving an adhesive, such as epoxy, the liner is manufactured to have an outer diameter slightly smaller than the inner diameter of the pipe such that it can be freely slid into the pipe without the use of mechanical reduction equipment. In the following Examples, this technique of inserting the liner in the pipe will be referred to as a “slip-fit”.

### Comparative Example A

### PFA on Base Steel

A PFA liner of ˜1300 micrometers (50 mil) thickness is inserted into a grit-blasted pipe via interference lining. The lined pipe is placed in a standard convection oven (air atmosphere) which has been preheated to 610° F. (321° C.). Once the sample reaches the target temperature of 610° F., it remains in the oven for 15 additional minutes. Upon removing the sample from the oven, it is immediately obvious that the liner has collapsed and there is no adhesion between the liner and the pipe wall.

### Example 1

### PFA on Bare Steel

A preformed PFA liner of ˜1300 micrometers (50 mil) thickness is inserted into grit-blasted pipe via interference lining. The lined pipe is heated to 610° F. (321° C.) via induction heating. The induction heating conditions include: frequency=23 kHz, power level=10.3 kW, and scan rate=7.8 in/min. The benefit of induction heating is immediately obvious upon the completion of heating as the liner does not collapse and pull away from the pipe walls. Upon cooling, strips are cut from the lined pipe and the adhesion strength of the liner to the pipe is measured to be 25 lbf/in.

### Comparative Example B

### PFA with Primer and Barrier Layer

Primer is sprayed onto the inside of a grit-blasted pipe and dried for 10 minutes at 177° C. A barrier layer is then sprayed onto the primed pipe and dried for 10 min at 399° C. The primer layer is 5-10 microns thick. The barrier layer is 30-60 microns thick. A preformed PFA liner of ˜1300 micrometers (50 mils) thickness is inserted into grit-blasted pipe via interference lining. The lined pipe is placed in a standard convection oven (air atmosphere) which has been preheated to 610° F.(321° C.). Once the sample reaches the target temperature of 610° F., the sample remains in the oven for 15 minutes. Upon removing the sample from the oven, it is immediately obvious that the liner has collapsed and there is no measurable adhesion between the liner and the pipe wall.

### Example 2

### PFA with Primer & Barrier Layer

Primer is sprayed onto the inside of a grit-blasted pipe and dried for 10 minutes at 177° C. A barrier layer is then sprayed onto the primed pipe and dried for 10 minutes at 399° C. The primer layer is 5-10 microns thick. The barrier layer is 30-60 microns thick. A preformed PFA liner of ˜1300 micrometers (50 mil) thickness is inserted into grit-blasted pipe via interference lining. The lined pipe is heated to 580° F. (304° C.) via induction heating. The induction heating conditions include: frequency=23 kHz, power level=24 kW, and scan rate=19 in/min. Upon cooling, strips are cut from the lined pipe and the adhesion strength of the liner to the pipe is measured to be 15 lbf/in.

### Comparative Example C

### PFA with ECCOBOND® A 359 Epoxy

A preformed PFA liner of ˜1300 micrometers (50 mil) thickness is chemically etched using a solution of sodium in liquid ammonia. The outside of the liner is then “painted” with a coat of ECCOBOND 359. The liner, now coated with epoxy, is slid into a grit-blasted pipe and has a snug “slip-fit”. The lined pipe is placed in a standard convection oven which has been preheated to 392° F. (200° C.). Once the sample reaches the target temperature of 392° F., the sample remains in the oven for 15 minutes. After removing the sample from the oven and allowing it to cool, the sample is cut into strips and adhesion strength of the liner to the pipe wall is measured to be 40 lbf/in.

### Example 3

### PFA with ECCOBOND® A 359 Epoxy

A preformed PFA liner of ˜1300 micrometers (50 mil) thickness is chemically etched using a solution of sodium in liquid ammonia. The outside of the liner is then “painted” with a coat of ECCOBOND A 359 adhesive. The liner, now coated with epoxy, is slid into a grit-blasted pipe and has a snug “slip-fit”. The lined pipe is heated to 420° F. (2160) via induction heating. The induction heating conditions include: frequency=23 kHz, power level=15 kW, and scan rate=20 in/min. Upon cooling, strips are cut from the lined pipe and the adhesion strength of the liner to the pipe is measured to be 40 lbf/in.

### Comparative Example D

### PTFE with Primer and Barrier Layer

Primer is sprayed onto the inside of a grit-blasted pipe and dried for 10 minutes at 177° C. A barrier layer is then sprayed onto the primed pipe and dried for 10 minutes at 399° C. The primer layer is 5-10 microns thick. The barrier layer is 30-60 microns thick. A preformed PTFE liner of ˜3900 micrometers (150 mil) thickness is inserted into a grit-blasted pipe via interference lining. The lined pipe is placed in a standard convection oven (air atmosphere) which has been preheated to 610° F. (320° C.). Once the sample reaches the target temperature of 610° F., the sample remains in the oven for 15 minutes. Upon removing the sample from the oven and allowing it to cool, it is immediately obvious that there is no adhesion between the pipe wall and the liner as the liner slides freely out of the pipe. It is observed that the outside of the liner now is coated with the barrier layer material indicating that adhesion did occur but that shrinkage forces upon cool down were greater than the adhesion forces enabling the liner to slide freely out of the pipe.

### Example 4

### PTFE with Primer and Barrier Layer

Primer is sprayed onto the inside of a grit-blasted pipe and dried for 10 minutes at 177° C. A barrier layer is then sprayed onto the primed pipe and dried for 10 minutes at 399° C. The primer layer is 5-10 microns thick. The barrier layer is 30-60 microns thick. A preformed PTFE liner of ˜3900 micrometers (150 mil) thickness is inserted into grit-blasted pipe via interference lining. The lined pipe is heated to 550° F. (288° C.) via induction heating. The induction heating conditions include: frequency=23 kHz, power level=24 kW, and scan rate=21 in/min. Upon cooling, strips are cut from the liner pipe and the adhesion strength of the liner to the pipe is measured to be 20 lbf/in.

### Comparative Example E

### PTFE with ECCOBOND® 359 Epoxy

A preformed PTFE liner of ˜3900 micrometers (150 mil) thickness is chemically etched using a solution of sodium in liquid ammonia. The outside of the liner is then “painted” with a coat of ECCOBOND 359 adhesive. The liner, now coated with epoxy, is slid into a grit-blasted pipe and has a snug “slip-fit”. The lined pipe is placed in a standard convection oven which has been preheated to 392° F. (200° C.). Once the sample reaches the target temperature of 392° F., the sample remains in the oven for 15 minutes. After removing the sample from the oven and allowing it to cool, the sample is cut into strips and adhesion strength of the liner to the pipe wall is 50 lbf/in.

### Example 5

### PTFE with ECCOBOND® 359 Epoxy

A preformed PTFE liner of ˜3900 micrometers (150 mil) thickness is chemically etched using a solution of sodium in liquid ammonia. The outside of the liner is then “painted” with a coat of ECCOBOND 359 adhesive. The liner, now coated with epoxy, is slid into a grit-blasted pipe and has a snug “slip-fit”. The lined pipe is induction heated to 420° F.( 216° C.). Induction heating conditions include: frequency=23 kHz, power level=15 kW, and scan rate=20 in/min. After the sample cools, it is cut into strips and adhesion strength of the liner to the pipe wall is 50 lbf/in.

TABLE 5
Summary of Examples

| | | Heating | |
|---|---|---|---|
| Example | Sample | Technique | Adhesive Strength |
| Comp A | PFA on bare steel | Convection | 0 lbf/in - |
| | | Oven | liner collapsed |
| 1 | PFA on bare steel | Induction | 25 lbf/in |
| | | Heating | |
| Comp B | PFA with primer | Convection | 0 lbf/in - |
| | and barrier layer | Oven | liner collapsed |
| 2 | PFA with primer | Induction | 15 lbf/in |
| | and barrier layer | Heating | |
| Comp C | PFA with | Convection | 40 lbf/in |
| | ECCOBOND ® 359 | Oven | |
| | epoxy | | |
| 3 | PFA with | Induction | 40 lbf/in |
| | ECCOBOND ® 359 | Heating | |
| | epoxy | | |
| Comp D | PTFE with primer | Convection | 0 lbf/in - |
| | and barrier layer | Oven | liner pulled away |
| | | | from pipe wall |
| 4 | PTFE with primer | Induction | 20 lbf/in |
| | and barrier layer | Heating | |
| Comp E | PTFE with | Convection | 50 lbf/in |
| | ECCOBOND ® 359 | Oven | |
| | epoxy | | |
| 5 | PTFE with | Induction | 50 lbf/in |
| | ECCOBOND ® 359 | Heating | |
| | epoxy | | |

What is claimed is:

1. A process for adhering a preformed liner to the interior surface of a pipe, comprising induction heating the pipe to conduct heat to the liner, thereby adhering the liner to the surface of the pipe, wherein the preformed liner is a polymer.

2. A process for adhering a preformed liner to the interior surface of an oil well pipe, comprising induction heating the pipe to conduct heat to the liner, thereby adhering the liner to the surface of the pipe, wherein the preformed liner is a polymer.

3. A process for adhering a preformed liner to the interior and/or exterior surface of a pipe, comprising induction heating the pipe to conduct heat to the liner, thereby adhering the liner to the surface of the pipe, wherein the preformed liner comprises a fluoropolymer.

4. The process of claim 1, 2 or 3 wherein the preformed liner adhered to the surface of the pipe has a peel strength of at least ten pounds force per inch (10 lbf/in).

5. The process of claim 1, 2 or 3, further comprising applying a primer layer to the interior surface of the pipe for adhering the liner to pipe.

6. The process of claim 1, 2 or 3, further comprising applying an adhesive to the interior surface of the pipe or the exterior surface of the preformed liner for adhering the liner to the pipe.

7. The process of claim 5, further comprising a barrier layer applied on top of the primer layer comprising a plurality of particles which form a mechanical barrier against permeation of water to the pipe.

8. The process of claim 7, wherein the particles comprise mica.

9. The process of claim 7, wherein the barrier layer comprises a fluoropolymer.

10. The process of claim 5, wherein the primer layer is applied to interior surface of pipe prior to inserting the liner in the pipe.

11. The process of claim 6, wherein the adhesive is applied to the interior surface of the pipe or the exterior surface of the preformed liner prior to inserting the liner in the pipe.

12. The process of claim 1, 2 or 3, wherein the induction heating is applied to the outside of the pipe to heat the pipe, and the heat in the pipe adheres the liner to the surface of the pipe.

13. The process of claim 12, wherein the induction heating causes the liner to expand against the interior surface of the pipe.

14. The process of claim 1 or 2, wherein the liner comprises a fluoropolymer.

15. The process of claim 3, wherein the fluoropolymer is a melt-processible fluoropolymer.

16. The process of claim 14, wherein the fluoropolymer is a melt-processible fluoropolymer.

17. The process of claim 15 or 16, where the melt-processible fluoropolymer is selected from the group consisting of polychlorotrifluoroethylene, copolymers of tetrafluoroethylene (TFE) and copolymers of chlorotrifluoroethylene (CTFE).

18. The process of claim 17, wherein the melt processible fluoropolymer is a copolymer of TFE, wherein a comonomer is selected from the group consisting of a perfluoroolefin having 3 to 8 carbon atoms and a perfluoro(alkyl vinyl ether) (PAVE) in which the linear or branched alkyl group contains 1 to 5 carbon atoms.

19. The process of claim 14, where the liner comprises a non-melt processible fluoropolymer.

20. The process of claim 19, wherein the non-melt processible fluoropolymer is polytetrafluoroethylene (PTFE) or modified PTFE.

21. The process of claim 20, wherein the exterior surface of the preformed liner is etched.

22. The process of claim 21, wherein an adhesive is applied to either the exterior surface of the preformed liner or the interior surface of the pipe.
